(19) United States
(12) Patent Application Publication
(10) Pub. No.: US 2019/0377764 A1
(43) Pub. Date: Dec. 12, 2019

(54) ILLEGAL CONTENT SEARCH SYSTEM AND METHOD THEREOF

(71) Applicant: MWSTORY CO., LTD., Seoul (KR)

(72) Inventor: Dae Gull RYU, Seoul (KR)

(73) Assignee: MWSTORY Co., Ltd., Seoul (KR)

(21) Appl. No.: 16/312,032

(22) PCT Filed: Nov. 28, 2017
(86) PCT No.: PCT/KR2017/013642

§ 371 Date: Dec. 20, 2018

(30) Foreign Application Priority Data
Dec. 30, 2016 (KR) 10-2016-0184155
Sep. 26, 2017 (KR) 10-2017-0124164

(51) Int. Cl. G06F 16/951; G06F 16/906; H04L 29/06

(52) U.S. Cl. CPC G06F 16/951; H04L 63/10; G06F 16/906

(57) ABSTRACT

The illegal content searching system and the searching method thereof according to the present invention detect illegally distributed contents, such as webtoons, sound sources, books, and videos including web information which uses a modified keyword, to protect the copyright holder and teenagers. The illegal content searching system of the present invention includes a crawling server which searches a plurality of websites to detect the illegal contents which are illegally copied and distributed from a plurality of websites.

### CROSS-REFERENCE TO RELATED APPLICATIONS

This application claims priorities from Korean Patent Application No. 10-2016-0184155, filed on 30 Dec. 2016, and Korean Patent Application No. 10-2017-0124164, filed on 26 Sep. 2017 which are hereby incorporated by reference for all purposes as if fully set forth herein.

### BACKGROUND OF THE INVENTION

### 1. Field of the Invention

The present invention relates to an illegal content searching system which detects illegally distributed contents, such as webtoons, sound sources, books, and videos including web information which uses a modified keyword, to protect a copyright holder and teenagers and a method thereof.

### 2. Description of the Related Art

With the advent of the information society, various digital contents such as webtoons, sound sources, books, and videos are freely distributed and circulated through information providing media such as websites. Therefore, the digital contents may be shared by anyone anywhere in the world. In the meantime, as compared with rapid spread of the digital contents, user's recognition for protection of copyright of the digital contents is far from enough. Therefore, in order to overcome the problem, website monitoring to detect illegal distribution of digital contents is considered as important means in the information society.

A method for protecting the copyright of the digital contents may be divided into a proactive measure which makes it difficult to copy, distribute, and circulate the copyright work and a post-measure which detects and cracks down the copyright work which is illegally copied, distributed, and circulated.

The proactive measure has been technologically developed in many ways, such as a watermarking technique which prevents the copy or limits the number of copies. However, the methods based on the proactive measures have been mostly ineffective due to the development of technologies which arbitrarily remove the restrictions. Further, the proactive measures prohibit copy which does not correspond to the direct infringement of the copyright work so that the actual application thereof is frequently insignificant.

Therefore, in order to restrict illegal copy, circulation, and distribution of the digital contents, it is necessary to consistently monitor the websites using the post-measures and expose the illegal circulation of the digital contents at the same time.

However, the digital contents which are currently illegally circulated are detected mainly by a manual task of copyright holders or consignment organizations which manage the copyright in trust to voluntarily access the website and detect the illegally circulated digital contents. According to this method, it is very difficult to monitor and detect multitudinous websites. Further, even though the websites are detected, when a new copyright infringement case is added to the detected websites, the consistent monitoring may become useless unless reconnection and redetection are performed.

In the related art, in order to detect the circulation of the illegally copied copyright work, a crawler is used. The crawler thoroughly visits enormous web pages and automatically collects various information to perform a function of detecting illegally copied copyright works. However, the crawler of the related art searches the illegally copied copyright works only using limited keywords, so that it is difficult to determine whether the copyright work is illegally copied from web information including a modified keyword. Further, websites to be managed consistently expose the digital contents which are illegally circulated, by blocking unique information such as IP or ID of a website monitoring server.

### PRIOR ART DOCUMENT

### Patent Document

Korean Patent Registration No. 10-1634754 (firm date: Jul. 22, 2016)

### SUMMARY OF THE INVENTION

A technical object to be achieved by the present invention is to provide an illegal content searching system which detects illegally distributed contents, such as webtoons, sound sources, books, and videos including web information which uses a modified keyword, to protect a copyright holder and teenagers and a method thereof.

In order to achieve the above-described objects, the illegal content searching system of the present invention includes a website and a crawling server. In a plurality of websites, web information is stored. The crawling server may access the website to collect first illegal web information including at least one syllable corresponding to an original keyword among syllables of a first modified keyword included in the web information, divide the first modified keyword of the first illegal web information into phonemes or phonemes and special characters to generate a second modified keyword in which phonemes excluding the special characteristic are sequentially combined, determine whether the second modified keyword matches the original keyword, and if the keywords matches, classify the first illegal web information including the second modified keyword which matches the original keyword as second illegal web information. Further, the crawling server may access the website using at least one unique authority information among a plurality of unique authority information having an access right to the website.

The crawling server may divide phonemes of the second modified keyword and insert different special characters into the divided phonemes of the second modified keyword, and then sequentially combine the phonemes and special characters to generate a third modified keyword and collect the first illegal web information including at least one syllable corresponding to the third modified keyword, among syllables of the first modified keyword using the third modified keyword.

The crawling server may interwork with a search site to add a related keyword related to the original keyword and collect the first illegal web information including at least one syllable corresponding to the related keyword, among the syllables of the first modified keyword, using the related keyword.

The crawling server may convert the original keyword into a converted keyword corresponding to languages of various countries and collect the first illegal web information including at least one syllable corresponding to the converted keyword, among the syllables of the first modified keyword, using the converted keyword.

When the unique authority information is blocked from the website, the crawling server may consistently access the website using another unique authority information excluding the blocked unique authority information.

When the unique authority information is blocked from the website, the crawling server may automatically substitute another unique authority information for script information which issues an access command to allow the crawling server to access the website and collect the first illegal web information.

The crawling server may store a mapping table in which the unique authority information blocked from the website and the website which blocks the unique authority information are mapped to each other, when the other unique authority information is blocked from the website which blocks the unique authority information, extract the unique authority information corresponding to the website which blocks the unique authority information from the mapping table, and resume the accessing to the website which blocks the unique authority information using the extracted unique authority information depending on whether the extracted unique authority information is unblocked.

As described above, the illegal content searching system and the searching method thereof according to the present invention detect illegally distributed contents, such as webtoons, sound sources, books, and videos including web information which uses a modified keyword, to protect the copyright holders and teenagers.

In the system and the method for searching illegal contents according to the present invention, another modified keyword is generated from a modified keyword, so that a probability of detecting illegally distributed contents including web information which uses variously modified keywords is increased.

Further, in the system and the method for searching illegal contents according to the present invention, related keywords related to a keyword are used to widely search illegally distributed contents.

Moreover, in the system and the method for searching illegal contents according to the present invention, converted keywords corresponding languages of respective countries are used so that illegally distributed contents may be found out in each country.

### BRIEF DESCRIPTION OF THE DRAWINGS

FIG. 1 is a view illustrating a configuration of an illegal content searching system according to the present invention;

FIG. 2 is a view illustrating a configuration of a crawling server of FIG. 1;

FIG. 3 is a view illustrating a mapping table of FIG. 2;

FIGS. 4A to 4C are views illustrating a monitoring interface for a crawling server of FIG. 2; and

FIG. 5 is a view illustrating an illegal content searching method according to the present invention.

### DETAILED DESCRIPTION OF THE EMBODIMENTS

Embodiments of the present invention may be modified in various forms, and the scope of the present invention is not interpreted as being limited to the exemplary embodiments described below. The embodiments are provided for more completely explaining the present invention to those skilled in the art. In order to sufficiently understand the present invention, the operational advantages of the present invention, and the objectives achieved by the embodiments of the present invention, the accompanying drawings illustrating preferred embodiments of the present invention and the contents described therein need to be referred to.

Hereinafter, exemplary embodiments of an illegal content searching system and a method thereof according to the present invention will be described in detail with reference to the accompanying drawings.

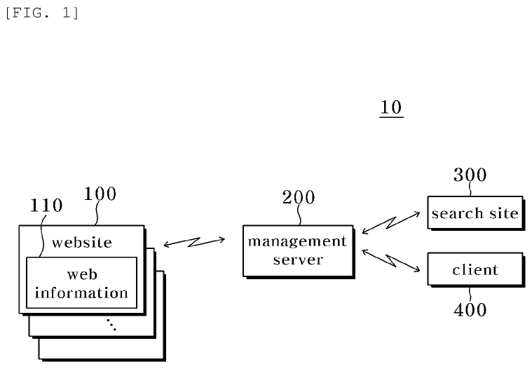

FIG. 1 is a view illustrating a configuration of an illegal content searching system according to the present invention.

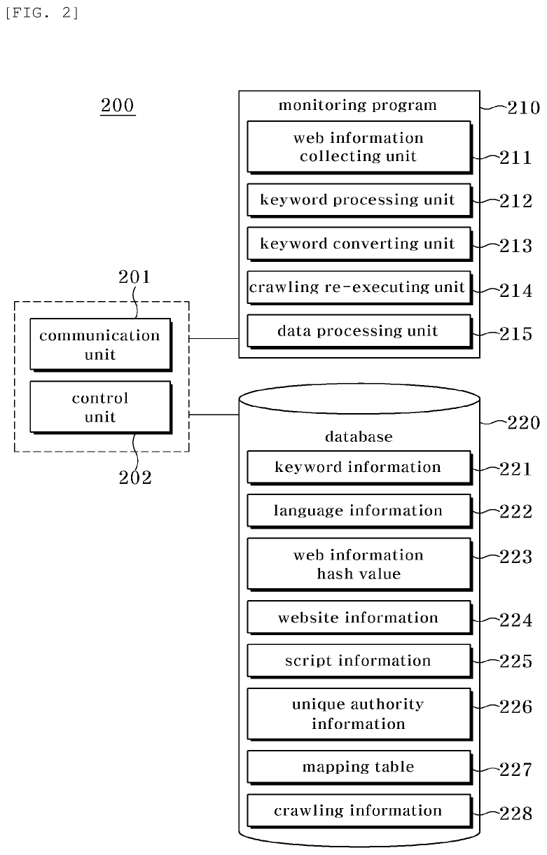

Referring to FIG. 1, an illegal content searching system 10 according to the present invention detects illegal contents from a plurality of websites 100 in which web information is stored, using a crawling server 200. That is, the illegal content searching system 10 sets an original keyword, a keyword modified from the modified keyword, related keywords, and modified keywords according to languages of various countries as a search word to protect copyright holders of the illegal contents and teenagers who are not allowed to access the illegal contents, thereby increasing a search accuracy of illegal contents. Here, illegal contents include not only literary works, musical works, theatrical works, art works, photographic works, visual works, graphic works, computer program works, and architectural works which violate the copyright law, but also adult video contents which are harmful to teenagers. Further, the illegal content searching system 10 newly adds related keywords which are recommended from a search site 300, which interworks with the crawling server 200, to be used at the time of searching illegal contents. Further, when the access of the crawling server 200 is blocked from the website 100, the illegal content searching system resets unique authority information (denoted by 226 in FIG. 2) having an access right to the website 100 to re-execute a monitoring operation. Further, the illegal content searching system 10 provides various information related to the monitoring operation of the crawling server 200 to a client 400 to allow a manager of the crawling server 200 and an original copyright holder of the illegal content to check the information. Such an illegal content searching system 10 includes the website 100, the crawling server 200, the search site 300, and the client 400.

The website 100 stores web information 110 including various digital contents such as webtoons, sound sources, videos, and books. Further, the website 100 approves the unique authority information 226 having an access right to the website 100 to search web information 110, that is, approves the monitoring. Moreover, the websites 100 are scattered in various places without discriminating the places so that it is assumed that the web information 110 is uploaded by individual website managers. Specifically, the web information 110 includes identifiable attribute information such as a tag so that when the monitoring is performed by the crawling server 200, the attribute information may be provided. A configuration and an operation of the crawling server 200 will be described further with reference to FIGS. 2 to 4C.

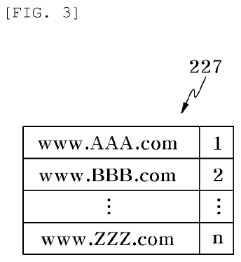

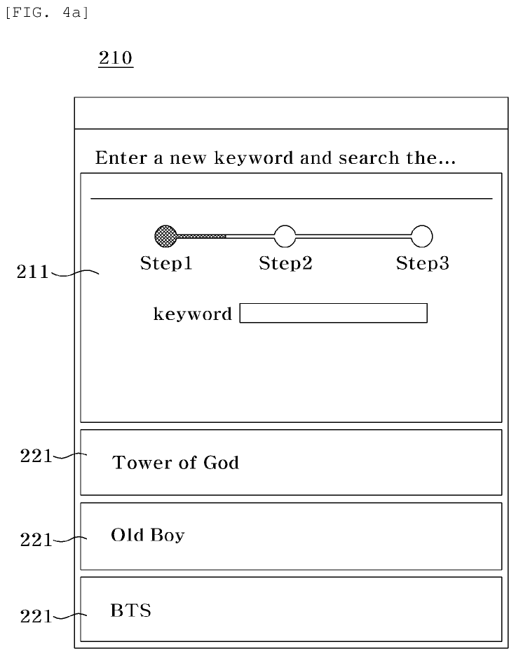

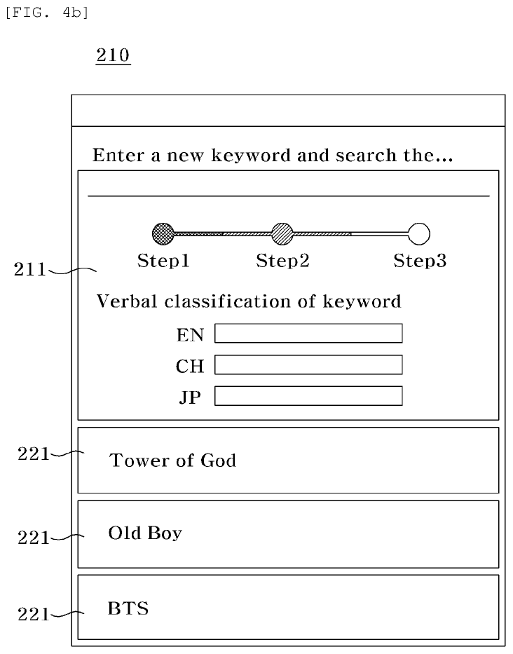

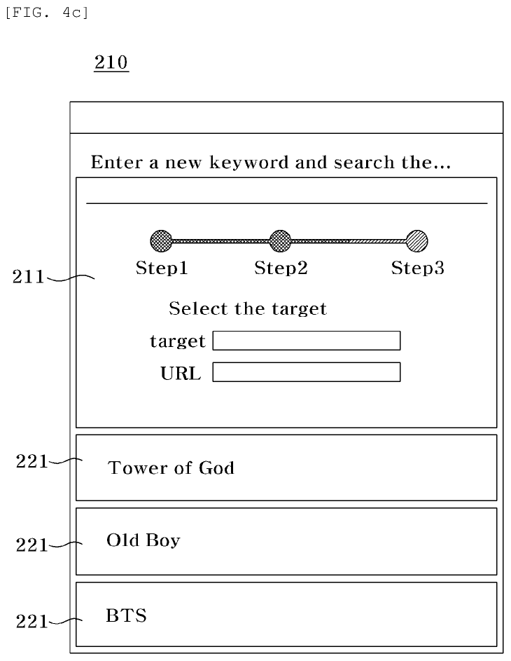

FIG. 2 is a view illustrating a configuration of a crawling server of FIG. 1. FIG. 3 is a view illustrating a mapping table of FIG. 2. FIGS. 4A to 4C are views illustrating a monitoring interface for a crawling server of FIG. 2.

The crawling server 200 is connected to the website 100, the search site 300, and the client 400 through a communication path such as a communication network to detect illegal contents which are illegally copied and distributed from the website 100 and receives related keywords related to the illegal contents recommended from the search site 300 to use the related keyword for the monitoring operation. Further, the crawling server 200 accesses the website 100 using at least one of the plurality of unique authority information 226 and not only provides consistent access to the website 100 in response to the blocking of the access from the website 100, but also provides various information related to the monitoring operation to the client 400. Such a crawling server 200 is located in various countries in the world to perform the monitoring operation and for example, even though it is not illustrated in the drawing, the crawling server 200 may perform the monitoring operation in accordance with the control of the management server (not illustrated). Such a crawling server 200 includes a communication unit 201, a control unit 202, a monitoring program 210, and a database 220.

The communication unit 201 processes the crawling server 200 to perform data communication with a plurality of websites 100, the search site 300, and the client 400 through a communication path such as a communication network. That is, the communication unit 201 may transmit all signals including information transmitted between the crawling server 200 and the website 100, the search site 300, and the client 400.

The control unit 202 controls an overall operation of the crawling server 200 using the monitoring program 210. That is, the control unit 202 controls the communication unit 201, the monitoring program 210, and the database 220. For example, at least one of arithmetic devices such as a general-purpose central processing unit, a programmable device element (CPLD or FPGA) which is implemented to be suitable for a specific purpose, an application specific semiconductor device (ASIC), and a microcontroller chip may be provided as the control unit 202.

The monitoring program 210 accesses the website 100 through the communication unit 201 to search and detect the illegal contents by setting an original keyword, a keyword modified from the modified keyword, a related keyword, and a modified keyword according to languages of the various countries, as a search word. Further, the monitoring program 210 adds a related keyword to be used to monitor the illegal contents, from the search site 300, to use the added related keyword for the search. Further, even though the access of the crawling server 200 is blocked from the website 100, the monitoring program 210 resets the unique authority information 226 to re-execute the monitoring operation and provides various information related to the monitoring operation of the monitoring program 210 to the client 400 so as to allow the manager of the crawling server 200 or an original copyright holder of the illegal content to check the information. The monitoring program 210 includes a web information collecting unit 211, a keyword processing unit 212, a keyword converting unit 213, a crawling re-executing unit 214, and a data processing unit 215.

The web information collecting unit 211 accesses the website 100 using the unique authority information 226 to collect first illegal web information including at least one syllable corresponding to the original keyword among syllables of the first modified keyword included in the web information 110. The original keyword may refer to an original name of the illegal content and the first modified keyword may refer to a name in which a morpheme of the original keyword is modified. That is, the original keyword includes, for example, a syllable and a morpheme of a movie title “avatar”, but the first modified keyword may include a syllable of “a_va_tar” obtained by modifying the original movie title “Avatar”. Further, the web information collecting unit 211 may be provided as a computer program which performs a searching and indexing function, such as a crawler.

The keyword processing unit 212 divides the first modified keyword of the first illegal web information collected by the web information collecting unit 211 into phonemes or phonemes and special characters to generate a second modified keyword in which phonemes excluding the special characters are sequentially combined. That is, the keyword processing unit 212 extracts phonemes which are coupled to be used as a syllable among divided phonemes of the first modified keyword including the phonemes of “a_va-tar” to generate a morpheme corresponding to a second modified keyword “avatar”. Next, the keyword processing unit 212 determines whether the generated second modified keyword matches the original keyword and if the keywords match, considers first illegal web information including the second modified keyword which matches the original keyword as second illegal web information, that is, an illegal content which is illegally copied and distributed to separately classify the second modified keyword. Further, the keyword processing unit 212 divides the phonemes of the second modified keyword and inserts different special characters into the divided phonemes of the second modified keyword and then sequentially combines the special characters and the phonemes to generate a third modified keyword. That is, for example, the keyword processing unit 212 inserts different special characters “*” and “#” into “a”, “v”, “a”, “t”, “a”, and “r” which are phonemes of the second modified keyword and then generate a third modified keyword “a*va#tar”. Next, the keyword processing unit 212 may allow the web information collecting unit 211 to collect first illegal web information including at least one syllable corresponding to the third modified keyword among syllables of the first modified keyword included in the web information 110 using the third modified keyword. In addition, the keyword processing unit 212 is supplied with a related keyword related to the original keyword from the search site 300 and additionally supplies the related keyword to the web information collecting unit 211 to search the first illegal web information so that the web information collecting unit 211 may collect the first illegal web information including at least one syllable corresponding to the related keyword among syllables of the first modified keyword using the related keyword. The related keyword may include “Sam Worthington” and “Zoe Saldana” which are related search words of “avatar”.

The keyword converting unit 213 converts an original keyword into a converted keyword corresponding to languages of various countries to allow the web information collecting unit 211 to collect the first illegal web information including at least one syllable corresponding to the converted keyword, among the syllables of the first modified keyword, using the converted keyword.

When the monitoring program 210 is blocked from accessing the website 100 which is being accessed during the monitoring operation, the crawling re-executing unit 214 resets the unique authority information 226 having the access right to the website 100 to allow the monitoring program 210 to consistently access the website 100. Specifically, when the monitoring program 210 is blocked from accessing the website which is being accessed during the monitoring operation, the crawling re-executing unit 214 stores a mapping table 227 in which the blocked unique authority information 226 and the web site 100 which blocks the unique authority information 226 are mapped to each other. Next, the crawling re-executing unit 214 resets the monitoring operation using another unique authority information 226 instead of the blocked unique authority information 226 to resume the accessing to the website 100. In this case, the crawling re-executing unit 214 substitutes another unique authority information for the script information 225 which issues an access command to access the website 100 and collect the first illegal web information, that is, a command to allow the access to the website 100. In addition, when another unique authority information 226 is blocked from the website 100 which blocks the unique authority information 226 again, the crawling re-executing unit 214 extracts the unique authority information 226 corresponding to the website 100 which blocks the unique authority information 226 from the mapping table 227 and resets the monitoring operation of the monitoring program 210 to resume the accessing to the website 100 which blocks the unique authority information 226 using the extracted unique authority information 226 depending on whether the extracted unique authority information 226 is unblocked.

The data processing unit 215 collects and processes the web information 110 collected by the crawling server 200 and executing situation of the crawling server 200 and statistic data related to the execution. The executing situation information and statistic information related to the execution of the crawling server 200 which are processed as described above are stored in the database 220.

Specifically, referring to FIGS. 4A to 4C, the monitoring program 210 selects at least one of an original keyword, a third modified keyword, a related keyword, and a modified keyword from the keyword information 221 to input the selected keyword to the web information collecting unit 211. Further, the monitoring program 210 is provided with a plurality of web information collecting units 210 to select the number of web information collecting units 211 to execute the monitoring operation.

The database 220 stores keyword information 221, language information 222, a web information hash value 223, website information 224, script information 225, and unique authority information 226 by the control of the control unit 202 and receives blocked unique authority information 226 and a website 100 which blocks the unique authority information 226 from the crawling re-executing unit 214 to store the information and the website in the mapping table 227 and receives executing situation information and statistic information from the data processing unit 215 to store the information as crawling information 228. The keyword information 221 includes an original keyword input by a manager, a first modified keyword, a second modified keyword, a third modified keyword, and a modified keyword which are collected or generated during the monitoring operation of the monitoring program 210. The keyword information 221 may be provided at the time of the monitoring operation of the monitoring program 210 or stored in the database 220 by the control unit 202 as a result of the monitoring operation of the monitoring program 210. The language information 222 includes language information of various countries which are provided to convert the original keyword into a modified keyword in the monitoring program 210. Further, the web information hash value 223 is a password for discerning illegally distributed web information 110 from a plurality of web information 110 and is supplied to the monitoring program 210 to verify identity of the second illegal web information and original web information 110 which is not illegally copied. Here, the website information 224 may include location records such as a uniform resource locator (URL) through which the website 100 is searched. That is, when the monitoring program 210 tries to execute the monitoring operation, the website information 224 provides the location records to provide information to allow the access to the website 100 to be monitored. The script information 225 includes a plurality of commands which issue an access command to allow the monitoring program 210 to access the website 100 and collect the first illegal web information. The unique authority information 226 may be identification information having an access right to the website 100, such as an internet protocol (IP) and an identification (ID) which is approved to access the website 100. Further, a plurality of unique authority information is provided so as to correspond to the blocking of at least one unique authority information 226 from the website 100. Referring to FIG. 3, specifically, the mapping table 227 may allow the blocked unique authority information 226 and the website 100 which blocks the unique authority information 226 to correspond one to one to each other. Although only one to one correspondence is illustrated in the drawing, it is obvious that when one website 100 overlaps for a plurality of blocked unique authority information 226, multiple-to-one correspondence is allowed therebetween. The crawling information 228 receives the executing situation information and statistic information from the data processing unit 213 and stores the information. Further, the crawling information 228 is provided to a manager of the crawling server 200 or the client 400 through an interface screen. First, the executing situation information is executing situation data related to the execution of the crawling server 200 and includes at least one of a location record such as an URL of the website 100 which the crawling server 200 accesses, whether to execute the crawling server 200, and log information of the crawling server 200. In the meantime, the statistic information is statistic data related to the execution of the crawling server 200 and includes first to fourth statistic information. The first statistic information indicates the number of first illegal web information collected from the crawling server 200. The second statistic information indicates the number of date-based first illegal web information collected from the crawling server 200. The third statistic information indicates the number of time-based first illegal web information collected from the crawling server 200. The fourth statistic information indicates the number of first illegal web information collecting cases accumulated in every website 100 from which the first illegal web information is collected by the crawling server 200. In addition, the first to fourth statistic information may be provided as a graph or a diagram to the client 400.

The search site 300 interworks with the crawling server 200 through the communication path such as a communication network to provide a related keyword related to the original keyword, that is, a related search word, in accordance with the request of the crawling server 200. The search site 300 has a search engine function and extracts the related keyword in accordance with the request of the crawling server 200 from the database in the search site 300.

The client 400 is an information providing unit which is provided to the manager of the crawling server 200 and the copyright holder to check the crawling server 200. The client 400 is equipped with a crawling viewer (not illustrated) to be supplied with the crawling information 228 from the crawling server 200. The crawling viewer not only has the viewer function, but also directly modifies the information. By doing this, the manager of the crawling server 200 may visit the website 100 through the modification of the script information 225 or website information 224 without directly visiting the location where the crawling server 200 is provided and the copyright holder may monitor that the copyright work is illegally distributed.

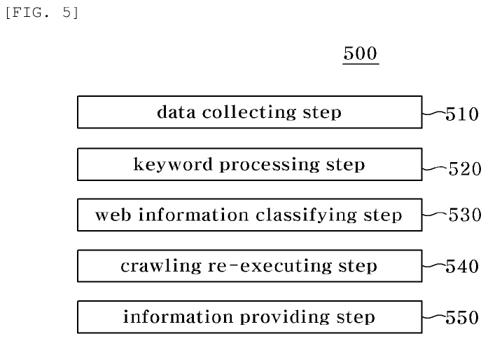

Specifically, a crawler remote managing method according to an embodiment of the present invention will be described in detail with reference to FIG. 5.

FIG. 5 is a view illustrating an illegal content searching method according to the present invention. In this exemplary embodiment, the illegal content searching method will be described in detail using components of the illegal content searching system 10 illustrated in FIGS. 1 to 4C.

Referring to FIG. 5, an illegal content searching method 500 according to an exemplary embodiment of the present invention includes a data collecting step 510, a data processing step 520, a web information classifying step 530, a crawling re-executing step 540, and an information providing step 550.

In the data collecting step 510, the crawling server 200 accesses the website 100 to collect first illegal web information including at least one syllable corresponding to the original keyword among syllables of the first modified keyword included in the web information 110.

In the data processing step 520, the crawling server 200 divides the first modified keyword of the first illegal web information into phonemes or into phonemes and special characters to generate a second modified keyword in which phonemes excluding special characters are sequentially combined. Further, in the data processing step 520, the crawling server 200 divides the phonemes of the second modified keyword and inserts different special characters into the divided phonemes of the second modified keyword and then sequentially combines the special characters and the phonemes to generate a third modified keyword. Further, in the data processing step 520, the crawling server 200 interworks with the search site 300 to add a related keyword related to the original keyword. In addition, in the data processing step 520, the crawling server 200 converts the original keyword into a converted keyword corresponding to languages in various countries. Moreover, in the data processing step 520, the crawling server 200 allows at least one of the third modified keyword, the related keyword, and the converted keyword which are generated or added in the data processing step 520 to be used in the data collecting step 510.

In the web information classifying step 530, the crawling server 200 determines whether the second modified keyword and the original keyword match and if the keywords match, classifies the first illegal web information including the second modified keyword which matches the original keyword as second illegal web information to detect the illegal content.

In the crawling re-executing step 540, the crawling server 200 controls to access the website using at least one unique authority information 226 among a plurality of unique authority information 226. In this case, in the crawling re-executing step 540, it is sensed whether the unique authority information 226 is blocked from the website 100 and when the unique authority information 226 is blocked from the website 100, the crawling server 200 accesses the website 100 using another unique authority information 226 excluding the blocked unique authority information 226. Further, in the crawling re-executing step 540, when the unique authority information 226 is blocked from the website 100, another unique authority information 226 is automatically substituted for the script information 225. In addition, in the crawling re-executing step 540, the crawling server 200 stores a mapping table 227 in which the unique authority information 226 blocked from the website 100 and the website 100 which blocks the unique authority information 226 are mapped to each other. In this case, in the crawling re-executing step 540, when another unique authority information 226 is blocked from the website 100 which blocks the unique authority information 226, the crawling server extracts the unique authority information 226 corresponding to the website 100 which blocks the unique authority information 226 from the mapping table 227 and resumes the access to the website 100 which blocks the unique authority information 226 using the extracted unique authority information 226 depending on whether the extracted unique authority information 226 is unblocked.

In the information providing step 550, the crawling server 200 provides executing situation information of the crawling server 200 and statistic information related to the execution of the crawling server 200 to the client 400.

Therefore, the crawler remote management system 10 according to the present invention monitors the crawling server 100 located in various countries to detect various digital contents, such as webtoons, sound sources, videos, and books, which are illegally copied and distributed in websites of various countries, consistently executes the crawling operation of the crawler 110 by setting a latency time and resetting unique authority information, and provides executing situation information and statistic information to the client 300 from the remote management server 200.

Although a configuration and an operation of the crawler remote management system according to the present invention has been described with reference to the detailed description and the drawings, this merely describes the embodiments and various modification and changes may be allowed without departing from the technical spirit of the present invention.

What is claimed is:

1. An illegal content searching system, comprising:
a website in which web information is stored; and
a crawling server which accesses the website to collect first illegal web information including at least one syllable corresponding to an original keyword among syllables of a first modified keyword included in the web information, divides the first modified keyword of the first illegal web information into phonemes or phonemes and special characters to generate a second modified keyword in which phonemes excluding the special characters are sequentially combined, determines whether the second modified keyword matches the original keyword, and if the keywords matches, classifies the first illegal web information including the second modified keyword which matches the original keyword as second illegal web information,
wherein the crawling server accesses the website using at least one unique authority information among a plurality of unique authority information having an access right to the website.

2. The illegal content searching system of claim 1, wherein the crawling server divides phonemes of the second modified keyword and inserts different special characters into the divided phonemes of the second modified keyword, and then sequentially combines the phonemes and special characters to generate a third modified keyword and collects the first illegal web information including at least one syllable corresponding to the third modified keyword, among the syllables of the first modified keyword using the third modified keyword.

3. The illegal content searching system of claim 1, wherein the crawling server interworks with a search site to add a related keyword related to the original keyword and collects the first illegal web information including at least one syllable corresponding to the related keyword, among the syllables of the first modified keyword, using the related keyword.

4. The illegal content searching system of claim 1, wherein the crawling server converts the original keyword into a converted keyword corresponding to languages of various countries and collects the first illegal web information including at least one syllable corresponding to the converted keyword, among the syllables of the first modified keyword, using the converted keyword.

5. The illegal content searching system of claim 1, wherein when the unique authority information is blocked from the website, the crawling server consistently accesses the website using another unique authority information excluding the blocked unique authority information.

6. The illegal content searching system of claim 1, wherein when the unique authority information is blocked from the website, the crawling server automatically substitutes another unique authority information for script information which issues an access command to allow the crawling server to access the website and collect the first illegal web information.

7. The illegal content searching system of claim 1, wherein the crawling server stores a mapping table in which the unique authority information blocked from the website and the website which blocks the unique authority information are mapped to each other, when another unique authority information is blocked from the website which blocks the unique authority information, extracts the unique authority information corresponding to the website which blocks the unique authority information from the mapping table, and resumes the accessing to the website which blocks the unique authority information using the extracted unique authority information depending on whether the extracted unique authority information is unblocked.
